(19) United States
(12) Patent Application Publication
(10) Pub. No.: US 2021/0123527 A1
(43) Pub. Date: Apr. 29, 2021

(54) SHIFTING MECHANISM

(71) Applicant: TOYOTA JIDOSHA KABUSHIKI KAISHA, Aichi (JP)

(72) Inventors: Hirotsugu YOSHINO, Shizuoka-ken (JP); Hiroaki EBUCHI, Hadano-shi (JP); Takahito ENDO, Shizuoka-ken (JP); Hiroki YASUI, Mishima-shi (JP)

(21) Appl. No.: 16/869,500

(22) Filed: May 7, 2020

(30) Foreign Application Priority Data
Oct. 28, 2019 (JP) 2019-194974

(51) Int. Cl. F16H 63/18; F16H 25/12

(52) U.S. Cl. CPC F16H 63/18; F16H 25/12

(57) ABSTRACT

A shifting mechanism whose axial length is reduced without increasing a manufacturing cost. The shifting mechanism comprises: a cylindrical cam; a serpentine cam groove formed on the cam; a cam follower contacted to the guide section to be reciprocated in an axial direction; and a shift fork connected to the cam follower. The cam follower is pushed onto one of walls of a cam groove serving as a guide wall by a pushing member.

The present disclosure claims the benefit of Japanese Patent Application No. 2019-194974 filed on Oct. 28, 2019 with the Japanese Patent Office, the disclosure of which is incorporated herein by reference in its entirety.

### BACKGROUND

### Field of the Disclosure

The present disclosure relates to the art of a shifting mechanism for shifting a gear stage or an operating mode in a power transmission unit in which the gear stage or the operating mode can be selected from a plurality of stages or modes.

### Discussion of the Related Art

One example of the shifting mechanism of this kind is described in JP-A-H07-127670. The shifting mechanism taught by JP-A-H07-127670 comprises a shift drum that is rotated by an actuator, and a shift rod that is reciprocated in an axial direction by rotating the shift drum. According to the teachings of JP-A-H07-127670, the shift drum is arranged in the rear section of a geared transmission while being supported rotatably by a casing, and a serpentine shift groove is formed on the shift drum. The shift rod extends in the axial direction while being allowed to reciprocate in the axial direction. A roller is attached to one end of the shift rod through a cylindrical member, and the roller is fitted into the shift groove. A shift fork is attached to the other end of the shift rod, and the shift fork is engaged with a plurality of synchronizers for shifting a gear stage.

The above-mentioned shift rod and shift drum are assembled in the casing in such a manner that deviations of positions of those members from designed positions fall within respective tolerance range. However, the shift rod is attached to the casing while being allowed to reciprocate in the axial direction of the shift drum. That is, an actual travel amount of the shift rod in the axial direction may be changed by the actual positions of the shift rod and the shift drum even if the deviations of those members fall within the respective tolerance range. If the actual travel amount of the shift rod in the axial direction is increased by the deviations of the shift rod and the shift drum from the designed positions, a width of the shift groove has to be set wider taking account of such deviations of those members. In addition, in order to prevent the synchronizer from being contacted to the transmission when positioned at a neutral position, a predetermined clearance is maintained between the transmission and the synchronizer. Since the synchronizer is reciprocated in the axial direction together with the shift rod, the clearance between the transmission and the synchronizer also has to be set wider if the actual travel amount of the shift rod in the axial direction is increased. Therefore, an axial length of the conventional shifting mechanism described in e.g., JP-A-H07-127670 has to be set longer taking account of the positional deviations of the shift rod and the shift drum. For example, the axial length of the conventional shifting mechanism may be reduced by arranging a positioning member or mechanism to reduce a positional deviation of the synchronizer. In this case, however, a high machining accuracy to process the parts and a high accuracy to install the parts are required. In addition, the number of parts is increased. Therefore, a man-hour and a cost to manufacture the shifting mechanism may be increased.

### SUMMARY

Aspects of preferred embodiments of the present disclosure have been conceived noting the foregoing technical problems, and it is therefore an object of the present disclosure to reduce a total axial length of a shifting mechanism without increasing a manufacturing cost.

An exemplary embodiment of the present disclosure relates to a shifting mechanism, comprising: a cylindrical cam that is rotated by a torque applied thereto; a guide section formed on the cam, that extends in a circumferential direction of the cam and that serpentines in an axial direction of the cam; a cam follower that is contacted to the guide section to be reciprocated in the axial direction by rotating the cam; and a shift fork that is connected to the cam follower. According to the exemplary embodiment of the present disclosure, the guide section includes at least: a guide wall to which the cam follower is contacted from one of the axial directions; and a cam groove having a pair of walls being opposed to each other in the axial direction. In order to achieve the above-explained objective, according to the exemplary embodiment of the present disclosure, the shifting mechanism is provided with a pushing member that pushes the cam follower onto the guide wall or one of the walls of the cam groove serving as the guide wall.

In a non-limiting embodiment, the pushing member may be adapted to elastically push the cam follower onto the guide wall.

In a non-limiting embodiment, the pushing member may be adapted to push the cam follower onto said one of the walls of the cam groove serving as the guide wall.

In a non-limiting embodiment, the shifting mechanism may be arranged in an automatic transmission to establish a predetermined gear stage of the automatic transmission by reciprocating the shift fork in the axial direction. In addition, the shifting mechanism may further comprise a dent that is formed on the guide section, at a location to which the cam follower is contacted to establish the predetermined gear stage of the automatic transmission.

In a non-limiting embodiment, the pushing member may be held in the cam groove together with the cam follower to push the cam follower onto said one of the walls serving as the guide wall.

Thus, according to the exemplary embodiment of the present disclosure, the cam follower is pushed by the pushing member toward one side in the axial directions to be contacted to the guide wall. According to the exemplary embodiment of the present disclosure, therefore, a resultant endplay created in the shifting mechanism in the other side can be reduced. For this reason, a total length of the shifting mechanism in the axial direction can be reduced. In addition, the shift fork connected to the cam follower is allowed to reciprocate quickly in a stable manner in response to the rotation of the cam. Further, the axial length of the shifting mechanism can be reduced at minimal cost by arranging only an extra pushing member, without altering sizes and dimensions of constitutional elements of the shifting mechanism.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a power transmission unit to which the shifting mechanism according to the embodiment of the present disclosure is applied;

FIG. 2 is a partial enlarged view showing the shifting mechanism according to a first example;

FIG. 3 is a partial enlarged view showing the shifting mechanism according to a second example;

FIG. 4 is a partial enlarged view showing the shifting mechanism according to a third example;

FIG. 5 is a partial enlarged view showing the shifting mechanism according to a fourth example;

FIG. 6 is a partial enlarged view showing a transient state of engagement in the shifting mechanism shown in FIG. 5;

FIG. 7 is a partial enlarged view showing the shifting mechanism according to a fifth example; and

FIG. 8 is a partial enlarged view showing the shifting mechanism according to a sixth example.

### DETAILED DESCRIPTION OF THE PREFERRED EMBODIMENT(S)

(First Example)

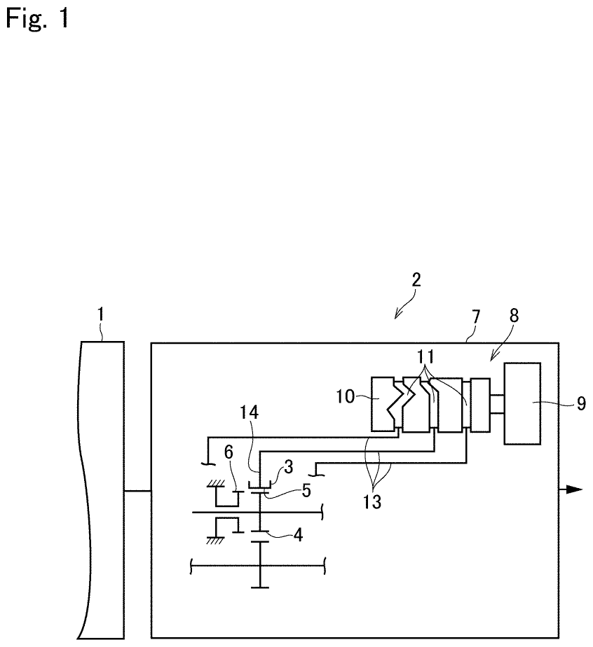

Preferred embodiments of the present application will now be explained with reference to the accompanying drawings. Referring now to FIG. 1, there is schematically shown one example of a power transmission unit of a vehicle to which the shifting mechanism according to the exemplary embodiment of the present disclosure is applied. As illustrated in FIG. 1, the power transmission unit comprises an internal combustion engine (as will be simply called the “engine” hereinafter) 1, and an automatic transmission (as will be simply called the “transmission” hereinafter) 2 arranged downstream of the engine 1. For example, a conventional gasoline engine may be adopted as the engine 1. An air intake to the engine 1 and a fuel injection to a combustion chamber of the engine 1 are increased by depressing an accelerator pedal (not shown). That is, an output power of the engine 1 is changed by manipulating the accelerator pedal. For example, a geared automatic transmission may be adopted as the transmission 2, and a gear stage of the transmission 2 is shifted among a plurality of stages in accordance with a depression of the accelerator pedal representing a required drive force and a running condition of the vehicle including a vehicle speed. A differential gear unit as a final reduction unit is connected to an output shaft of the transmission 2, and a torque delivered from the transmission 2 is distributed to a right drive wheel and a left drive wheel (neither of which are shown) through the differential gear unit.

In order to shift the gear stage to transmit torque, the transmission 2 is provided with a plurality of shift sleeves 3. In FIG. 1, however, only one shift sleeve 3 is depicted for the sake of illustration and explanation. The shift sleeve 3 is reciprocated in an axial direction (i.e., in a direction along a rotational center axis) to shift the gear stage of the transmission 2. Spline teeth (or spline grooves) 5 are formed on an inner circumferential surface of the shift sleeve 3 to be mated with a gear 4, and another spline teeth (or spline grooves) 6 are formed on a member fixed to a stationary member such as a casing 7. For example, the gear 4 is engaged with another spline teeth 6 through the shift sleeve 3 to establish a predetermined gear stage by moving the shift sleeve 3 in a direction to spline the spline teeth 5 to another spline teeth 6 (i.e., to the left side in FIG. 1). By contrast, the gear 4 is disengaged from another spline teeth 6 to establish another gear stage in which a gear ratio is different from that in the above-mentioned predetermined gear stage, by moving the shift sleeve 3 in a direction to isolate the spline teeth 5 from another spline teeth 6 (i.e., to the right side in FIG. 1).

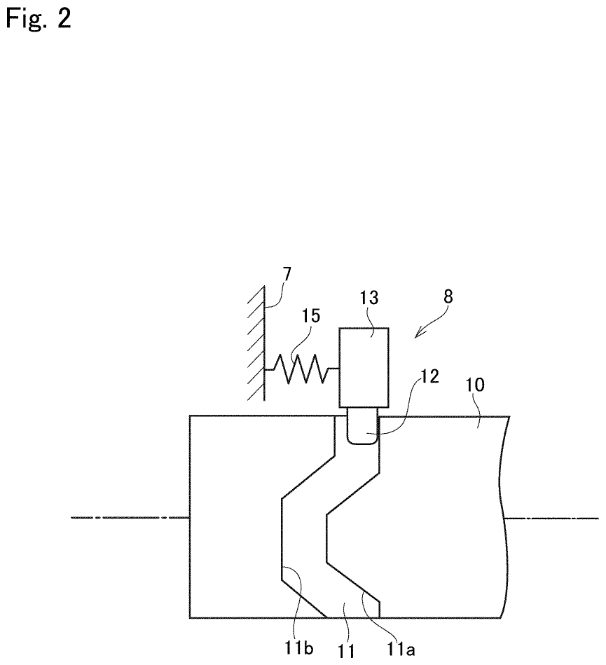

In the power transmission unit shown in FIG. 1, in order to shift the gear stage of the transmission 2, the shift sleeves 3 are reciprocated in the axial direction by a shifting mechanism 8. The shifting mechanism 8 comprises a cylindrical shift drum 10 as a cam that is rotated by an actuator 9. Specifically, the shift drum 10 is supported by the casing 7 in a rotatable manner, and the same number of cam grooves 11 as the shift sleeves 3 are formed on an outer circumferential surface of the shift drum 10. Each of the cam grooves 11 extends in a circumferential direction of the shift drum 10 respectively, and serpentines in an axial direction of the shift drum 10 respectively (i.e., in a zigzag manner). The same number of fork shafts 13 as the cam grooves 11 extends in the axial direction respectively, and a shift fork 14 is formed integrally with one end of each of the fork shafts 13. In the power transmission unit shown in FIG. 1, each of the shift forks 14 is individually shaped into a semicircular shape, and individually fitted onto an outer circumferential surface of each of the shift sleeves 3 while being allowed to rotate relatively with the shift sleeve 3 but to reciprocate integrally with the shift sleeve 3. Turning to FIG. 2, there is shown one of the fork shafts 13 and one of the cam grooves 11 of the shifting mechanism 8 according to the first example. As illustrated in FIG. 2, a pin 12 as a cam follower is attached to the other end of the fork shaft 13, and the pin 12 is inserted into the cam groove 11 while being allowed to slide along the cam groove 11. Thus, a rotary motion of the shift drum 10 is translated into a reciprocating motion of the shift sleeve 3.

As illustrated in FIG. 2, according to the first example, the cam groove 11 as a guide section of the embodiment of the present disclosure comprises a wall portion 11a and a wall portion 11b. A spring 15 as a pushing member is interposed between the casing 7 and the other end of the fork shaft 13 so that the pin 12 is elastically pushed onto one of the wall portions 11 a serving as a guide wall of the cam groove 11. Thus, in the shifting mechanism 8 as a positive cam mechanism, the pin 12 is always pushed onto the wall portion 11a by an elastic force of the spring 15.

According to the first example, therefore, it is possible to reduce an endplay between the fork shaft 13 and the shift drum 10. In other words, the fork shaft 13 can be positioned at a designed position while engaging the pin 12 closely with the guide wall 11a of the shift drum 10. For this reason, the fork shaft 13 is allowed to reciprocate quickly and accurately in the axial direction in response to the rotation of the shift drum 10, and hence a clearance between the shift sleeve 3 or the gear 4 and another spline teeth 6 in the axial direction can be reduced in accordance with an actual reciprocating range of the fork shaft 13 in the axial direction. For the reasons above, a length of the shifting mechanism 8 in the axial direction can be reduced.

In addition, since the pin 12 is pushed onto the guide wall 11a of the cam groove 11, the pin 12 is allowed to reciprocate accurately and stably in the axial direction along the guide wall 11a. That is, the fork shaft 13 can be reciprocated stably in the axial direction. Further, an elastic force of the spring 15 pushing the pin 12 onto the guide wall 11a will not be changed with a change in an axial position of the fork shaft 13. Therefore, a drive torque to rotate the shift drum 10 may be maintained to a constant torque, that is, the drive torque to rotate the shift drum 10 may be reduced compared to the conventional shifting mechanism. Furthermore, in the cam groove 11, only the guide wall 11a has to be smoothened and processed accurately. That is, since the pin 12 does not come into contact to the other wall portion 11b of the cam groove 11, it is not necessary to process the other wall portion 11b highly accurately. In other words, a smoothening process and a hardening process to smoothen and harden the other wall portion 11b of the cam groove 11 may be omitted. Therefore, the cam groove 11 may be processed easily, and a cost and a man-hour to process the cam groove 11 can be reduced.

(Second Example)

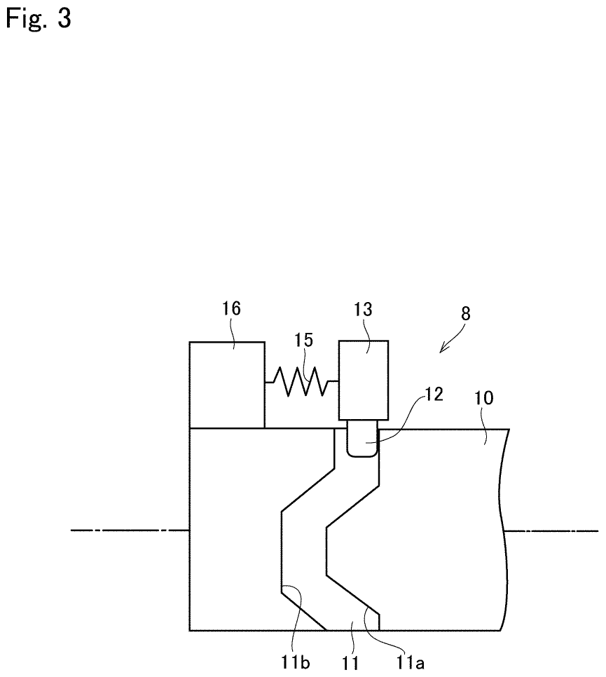

Turning to FIG. 3, there is shown one of the fork shafts 13 and one of the cam grooves 11 of the shifting mechanism 8 according to the second example in an enlarged scale. According to the second example, the spring 15 is interposed between the shift drum 10 and the fork shaft 13 to push the pin 12 attached to the other end of the fork shaft 13 onto the guide wall 11a of the cam groove 11. Specifically, a flange 16 protrudes radially outwardly from an outer circumferential surface of the shift drum 10, and the spring 15 is interposed between the flange 16 and the fork shaft 13. According to the second example, the above-explained advantages of the first example may also be achieved.

(Third Example)

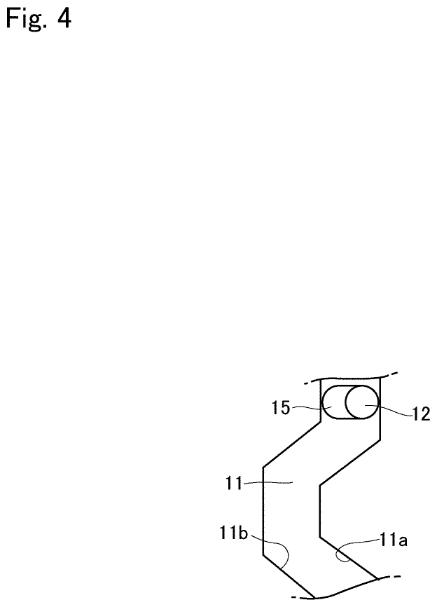

Turning to FIG. 4, there is shown one of the pins 12 and one of the cam grooves 11 of the shifting mechanism 8 according to the third example in an enlarged scale. According to the third example, the spring 15 is arranged in the cam groove 11 to push the pin 12 onto the guide wall 11a of the cam groove 11. Specifically, one end of the spring 15 is attached to an installation surface (not shown) formed on the pin 12, and other end of the spring 15 is contacted to the other wall portion 11b of the cam groove 11 in a slidable mariner. Optionally, a bush (not shown) may be attached to the other end of the spring 15 so that the other end of the spring 15 is contacted slidably to the other wall portion 11b. Thus, according to the third example, the spring 15 is held in the cam groove 11 while being compressed to push the pin 12 onto the guide wall 11a.

According to the third example, therefore, a member for receiving a reaction force of the spring 15 pushing the pin 12 onto the guide wall 11a such as the flange 16 of the second example can be omitted. In addition, the spring 15 is held in the cam groove 11, that is, situated radially inner side compared to the foregoing examples. For this reason, not only the axial length of the shifting mechanism 8 but also an outer diameter of the casing 7 can be reduced at least partially. In addition, the above-explained advantages of the first example may also be achieved by the shifting mechanism according to the third example.

(Fourth Example)

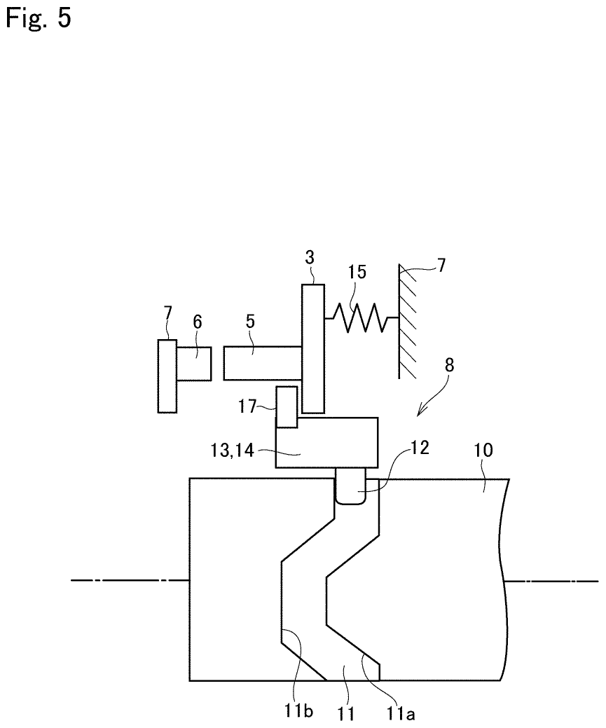

Turning to FIG. 5, there is shown one of the fork shafts 13 and one of the cam grooves 11 of the shifting mechanism 8 according to the fourth example in an enlarged scale. In the shifting mechanism 8, an interference between the spline teeth 5 formed on the inner circumferential surface of the shift sleeve 3 and another spline teeth 6 formed on the stationary member connected to the casing 7 may be caused if the spline teeth 5 and another spline teeth 6 are in phase with each other. In order to prevent such interference between the spline teeth 5 and another spline teeth 6, the shifting mechanism 8 according to the fourth example is adapted to adjust the phase of the spline teeth 5 thereby facilitating engagement of the shift sleeve 3 with another spline teeth 6. According to the fourth example, the shift fork 14 formed integrally with one end of the fork shaft 13 is engaged with the shift sleeves 3 while being allowed to rotate and reciprocate relatively with the shift sleeve 3. As illustrated in FIG. 5, according to the fourth example, the spring 15 is interposed between another side of the casing 7 and the shift sleeve 3 to push the shift sleeve 3 toward another spline teeth 6, and a stopper plate 17 is formed on an outer circumferential surface of the fork shaft 13 at said one end on which the shift fork 14 formed.

In the shifting mechanism 8 according to the fourth example, the shift sleeve 3 is elastically pushed by the spring 15 onto the stopper plate 17. Consequently, the spline teeth 5 is moved toward another spline teeth 6 to be splined thereto, and the fork shaft 13 is moved toward another spline 6 so that the pin 12 attached to the other end of the fork shaft 13 is pushed onto the other wall portion 11b of the cam groove 11. That is, according to the fourth example, the other wall portion 11b serves as a guide wall in the cam groove 11. When the shift drum 10 is rotated by the actuator 9, the pin 12 is reciprocated in the axial direction together with the shift fork 14 along the guide wall 11b. In this situation, if the spline teeth 5 and another spline teeth 6 are out of phase from each other, the spline teeth 5 are allowed to be splined smoothly to another spline teeth 6.

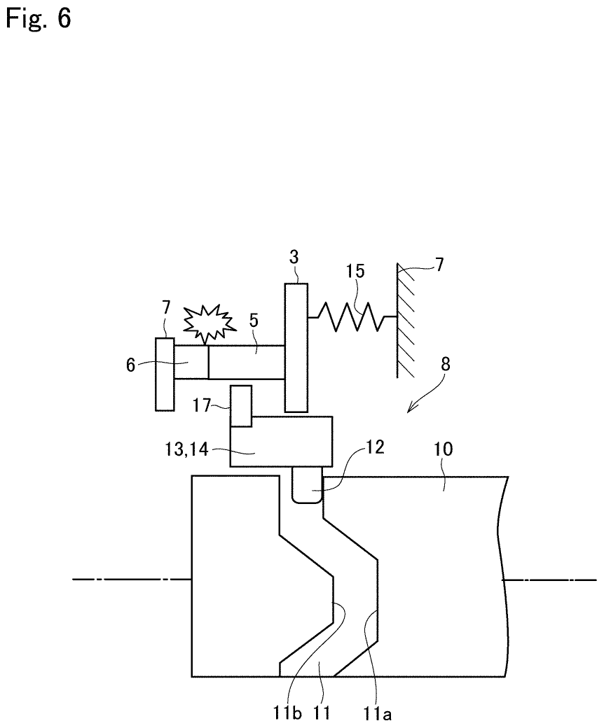

By contrast, if the spline teeth 5 and another spline teeth 6 are in phase with each other, an interference between the spline teeth 5 and another spline teeth 6 is caused as illustrated in FIG. 6. That is, the spline teeth 5 collides against another spline teeth 6 and the shift sleeve 3 is stopped temporarily. In this situation, the shift fork 14 and the fork shaft 13 are reciprocated in the axial direction as long as the shift drum 10 is rotated, and as described, the shift fork 14 is allowed to reciprocate relatively to the shift sleeve 3. Therefore, the stopper plate 17 is isolated away from the shift sleeve 3. Meanwhile, the gear 4 is rotated continuously so that the spline teeth 5 formed on the shift sleeve 3 are rotated by the gear 4 to be out of phase from another spline teeth 6. Consequently, the spline teeth 5 being pushed by the spring 15 through the shift sleeve 3 is splined smoothly to another spline teeth 6.

Thus, according to the fourth example, the fork shaft 13 is pushed by the spring 15 in the direction to push the pin 12 attached to the other end of the fork shaft 13 onto the other wall portion 11b. According to the fourth example, therefore, the end play created in the other side of the casing 7 in which e.g., the actuator 9 is held may be reduced. In addition, in the cam groove 11, only the other wall portion 11b has to be smoothened and processed accurately. In other words, it is not necessary to process the wall portion 11a highly accurately. For this reason, the cam groove 11 may also be processed easily, and a cost and a man-hour to process the cam groove 11 may also be reduced.

(Fifth Example)

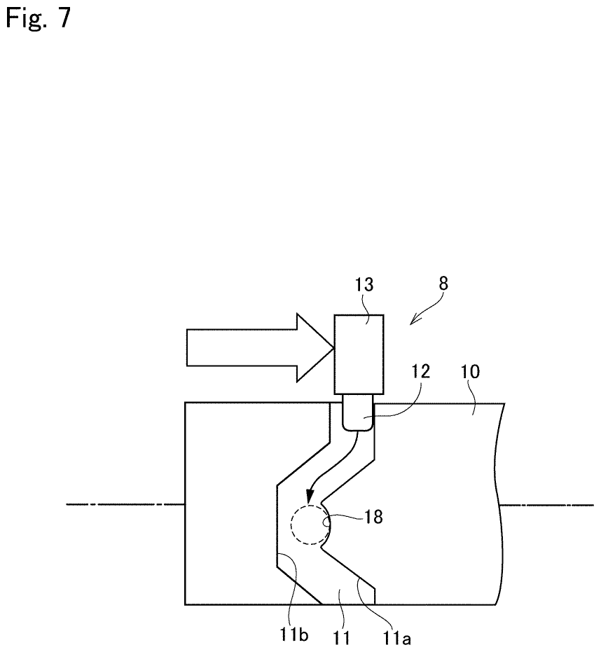

Turning to FIG. 7, there is shown one of the pins 12 and one of the cam grooves 11 of the shifting mechanism 8 according to the fifth example in an enlarged scale. The shifting mechanism 8 according to the fifth example is adapted to restrict an undesirable reciprocation of the pin 12 being pushed onto the guide wall 11a at a position to establish a predetermined gear stage of the transmission 2. In other words, the shifting mechanism 8 according to the fifth example is adapted to prevent an undesirable shifting of the gear stage of the transmission 2 due to vibrations or disturbance. In the shifting mechanism 8 according to the fifth example, for example, the pin 12 may be pushed onto the guide wall 11a of the cam groove 11 as illustrated in FIG. 7. In this case, the pin 12 may be pushed by arranging the spring 15 between the other end of the fork shaft 13 and the casing 7 or the flange 16 as the first example or the second example, or between the installation surface of the pin 12 and the other wall portion 11b as the third example. Instead, the pin 12 may also be pushed onto the other wall portion 11b of the cam groove 11. In this case, the pin 12 is pushed by arranging the spring 15 between another side of the casing 7 and the shift sleeve 3 as the fourth example, and the shift fork 14 is engaged with the shift sleeves 3 while being allowed to rotate and reciprocate relatively with the shift sleeve 3.

Hereinafter, the shifting mechanism 8 according to the fifth example will be explained based on the assumption that the pin 12 is pushed onto the guide wall 11a of the cam groove 11 as illustrated in FIG. 7. In the shifting mechanism 8 shown in FIG. 7, a dent 18 is formed on the guide wall 11a at a location to establish a predetermined gear stage of the transmission 2. Specifically, a diameter of the dent 18 is slightly larger than a diameter of the pin 12, and both ends of the dent 18 in the circumferential direction of the shift drum 10 are connected smoothly to the guide wall 11a. The diameter and a depth of the dent 18 are set in such a manner as to allow the pin 12 to exit smoothly from the dent 18 when shifting the gear stage to another stage, based on a result of experimentation. In a case of combining the fifth example with the fourth example, the dent 18 is formed on the other wall portion 11b at a location to establish a predetermined gear stage of the transmission 2. Here, a profile of the dent 18 may be changed according to need as long as the undesirable reciprocation of the pin 12 can be restricted.

Since the fork shaft 13 is also pushed in one of the axial directions in the shifting mechanism 8 according to the fifth example, the end play created in the other side of the shifting mechanism 8 may also be reduced. Further, only one of the wall portions 11a and 11b has to be smoothened and processed accurately, therefore, it is not necessary to process the other wall portion 11a or 11b highly accurately. For these reasons, as the foregoing examples, the axial length and the manufacturing cost of the shifting mechanism 8 can be reduced.

In addition to the advantages of the foregoing examples, according to the fifth example, it is possible to prevent an undesirable reciprocation of the pin 12 from the position to establish the predetermined gear stage by such a simple structure. According to the fifth example, therefore, the gear stage of the transmission 2 will not be shifted accidentally by the vibrations or the like during propulsion of the vehicle.

(Sixth Example)

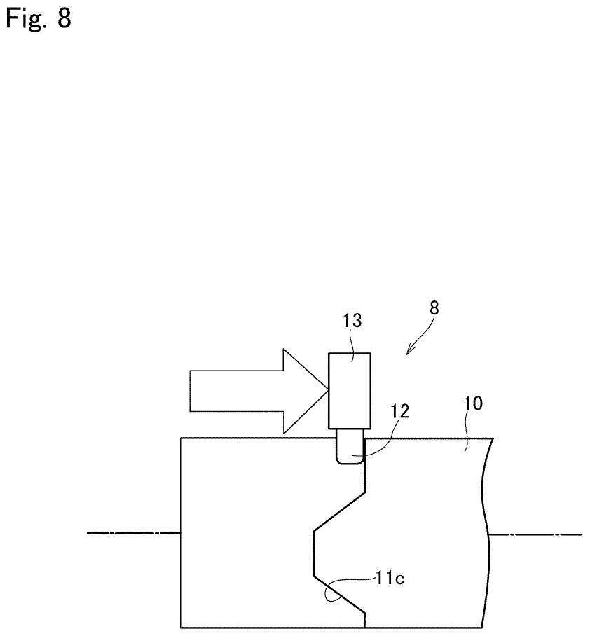

Turning to FIG. 8, there is shown one of the pins 12 and one of guide walls 11c of the shifting mechanism 8 according to the sixth example in an enlarged scale. As illustrated in FIG. 8, only the guide walls 11c to which the pin 12 is contacted respectively are formed on the outer circumferential surface of the shift drum 10 in the circumferential direction, instead of the cam grooves 11. For example, in the shifting mechanism 8 according to the sixth example, the pin 12 may be pushed onto the guide wall 11c by arranging the spring 15 between the other end of the fork shaft 13 and the casing 7 or the flange 16 as the first example or the second example. In this case, the guide wall 11c is formed in such a manner that an outer diameter the shift drum 10 is partially increased at a portion further than the pin 12 in the pushing direction (e.g., at a portion in the right side of the pin 12 in FIG. 8). Specifically, the guide wall 11c also has a serpentine configuration so that the pin 12 is reciprocated in the axial direction by rotating the shift drum 10 so as to actuate the shift sleeve 3 through the fork shaft 13.

Instead, the pin 12 may also be pushed by arranging the spring 15 between another side of the casing 7 and the shift sleeve 3 as the fourth example. In this case, the shift fork 14 is engaged with the shift sleeves 3 while being allowed to rotate and reciprocate relatively with the shift sleeve 3, and the guide wall 11c is formed in such a manner that an outer diameter the shift drum 10 is partially increased at a portion further than the pin 12 in the pushing direction (e.g., at a portion in the left side of the pin 12 in FIG. 8). Optionally, the dent 18 may be formed on the guide wall 11c at a location to establish a predetermined gear stage of the transmission 2.

Thus, in the shifting mechanism 8 according to the sixth example, only the guide walls 11c are formed on the shift drum 10 instead of the cam grooves 11. Therefore, in addition to the advantages of the foregoing examples, the structure of the shift drum 10 can be simplified compared to the foregoing examples. Since the guide wall 11c can be formed easier than the cam groove 11, the manufacturing cost of the shifting mechanism 8 according the eighth example can be further reduced. In addition, it is unnecessary to fit each of the pins 12 into narrow cam groove 11, and the pins 12 may be engaged easily with the respective guide walls 11c.

Although the above exemplary embodiment of the present application has been described, it will be understood by those skilled in the art that the shifting mechanism according to the present disclosure should not be limited to the described exemplary embodiment, and various changes and modifications can be made within the scope of the present disclosure.

For example, in the first example shown in FIG. 2, an arrangement of the spring 15 may be altered in such a manner as to push the fork shaft 13 in a direction to push the pin 12 onto the other wall portion 11b. In addition, the dent 18 shown in FIG. 7 may also be formed on a bottom surface of the cam groove 11 at a location to establish a predetermined gear stage of the transmission 2, instead of forming the dent 18 on the guide wall 11a.

What is claimed is:

1. A shifting mechanism, comprising:
a cylindrical cam that is rotated by a torque applied thereto;
a guide section formed on the cam, that extends in a circumferential direction of the cam and that serpentines in an axial direction of the cam;
a cam follower that is contacted to the guide section to be reciprocated in the axial direction by rotating the cam; and
a shift fork that is connected to the cam follower,
wherein the guide section includes at least
a guide wall to which the cam follower is contacted from one of the axial directions, and
a cam groove having a pair of walls being opposed to each other in the axial direction, and
the shifting mechanism further comprises a pushing member that pushes the cam follower onto the guide wall or one of the walls of the cam groove serving as the guide wall.

2. The shifting mechanism as claimed in claim 1, wherein the pushing member is adapted to elastically push the cam follower onto the guide wall.

3. The shifting mechanism as claimed in claim 1, wherein the pushing member is adapted to push the cam follower onto said one of the walls of the cam groove serving as the guide wall.

4. The shifting mechanism as claimed in claim 3,
wherein the shifting mechanism is arranged in an automatic transmission to establish a predetermined gear stage of the automatic transmission by reciprocating the shift fork in the axial direction, and
the shifting mechanism further comprises a dent that is formed on the guide section, at a location to which the cam follower is contacted to establish the predetermined gear stage of the automatic transmission.

5. The shifting mechanism as claimed in claim 3, wherein the pushing member is held in the cam groove together with the cam follower to push the cam follower onto said one of the walls serving as the guide wall.

6. The shifting mechanism as claimed in claim 4, wherein the pushing member is held in the cam groove together with the cam follower to push the cam follower onto said one of the walls serving as the guide wall.
